(19) United States
(12) Patent Application Publication
(10) Pub. No.: US 2016/0163002 A1
(43) Pub. Date: Jun. 9, 2016

(54) SYSTEM AND A METHOD FOR ITEMIZING THE FINANCIAL TRANSACTIONS OF A PURCHASER BASED ON ELECTRONIC RECEIPT INFORMATION

(71) Applicant: 1933503 Alberta Ltd., Edmonton (CA)

(72) Inventor: Ravi Brar, Edmonton (CA)

(21) Appl. No.: 14/957,246

(22) Filed: Dec. 2, 2015

Related U.S. Application Data
(60) Provisional application No. 62/086,729, filed on Dec. 3, 2014.

(51) Int. Cl. G06Q 40/00; G06Q 30/02

(52) U.S. Cl. CPC G06Q 40/128; G06Q 30/0255

(57) ABSTRACT

Disclosed is a system and a method for itemizing the financial transactions of a purchaser based on electronic receipt information generated corresponding to purchases of one or more items at a point-of-sale. The system includes a database, a processing unit coupled to the database, a registration module executable by the processing unit for creating a purchaser account on receiving the information related to the purchaser, further the purchaser account stores the electronic receipt information related to the purchaser received from the point of sale; a retrieval module executable by the processing unit for retrieving the items and the money spend on each item from the electronic receipt information related to purchases made by the purchaser at the point of sale; a categorization module executable by the processing unit for creating and storing categories of the items retrieved by the retrieval module in the purchaser account; a computing module executable by the processing unit for computing the information retrieved from the retrieval module and the categorization module for generating a graphical presentation of the money spend on each item purchased by the purchaser at the point of sale; and a display unit for displaying the data executed by the processing unit.

### CROSS-REFERENCE TO RELATED APPLICATIONS

The present application claims priority from the U.S. provisional patent application No. 62/086,729 filed on Dec. 3, 2014, and incorporates the entirety of same by reference herein.

### BACKGROUND OF THE INVENTION

1. Field of the Invention

The present invention generally relates to a method and a system for itemizing the financial transactions, and more particularly relates to a method and a system for itemizing the financial transactions of a purchaser based on electronic receipt information generated at point of sale.

2. Description of Related Art

Expense tracking systems require tracking and information of expenses done by purchasers on the purchases. Expenses made by purchasers may take a variety of forms such as shopping, travelling and meal expenses. In conventional expense tracking systems, a purchaser report all the expenses, accounting and taxation details to the merchant to keep track of the expenses made by the purchaser in the form of paper receipts.

The merchant organizes and reviews the expenses, accounting and taxation details to generate the report for tracking and tax purposes. This approach of tracking expenses requires a purchaser to store paper receipts for submitting to the merchant for generating the expense report. As the receipts are usually small pieces of paper, therefore it is hard to maintain the records of all receipts and hence the benefit of tracking expenses is lost.

Conventionally, the expense tracking systems requires a purchaser to enter expenses details from paper receipts. Sometimes while entering the details, even most of the experienced users are apt to make entry errors. User requires entering the expenses details according to the category. Since most purchasers are not aware of the details and meaning of some of the expenses categorizations that an accounting and taxation provides hence entry of these categorizations is prostrate to keying errors. The paper receipts require large amount of storage space, which adds further expenses to the business.

Many systems allow a user to use credit, debit and smart cards to pay for expenses. The expenses details using credit card data may be provided in electronic form to a user in the form of date, merchant, total bill and, an expense category. The particular expense is then linked with this information for tracking. Generally, credit card systems are not capable of collecting, storing and providing the full transaction details which is required for generating expenses report as the number of items purchased, purchaser identification, items description, etc.

Therefore, there is a need of a method and a system for generating and storing electronic receipts over a communication network. Further, the method and the system for itemizing the financial transactions of a purchaser based on electronic receipt information generated corresponding to sale of one or more items at a point-of-sale.

### SUMMARY OF THE INVENTION

In accordance with the teachings of the present invention, a method and a system for itemizing the financial transactions of a purchaser based on electronic receipt information generated corresponding to sale of one or more items at a point-of-sale.

An object of the present invention is to provide a method and a system for itemizing the financial transactions of a purchaser based on electronic receipt information generated corresponding to sale of one or more items at a point-of-sale. The system includes a database, a processing unit coupled to the database, a registration module, a retrieval module, a categorization module, a computing module executable by the processing unit, and a display unit to display information executed by the processing unit.

Another object of the present invention is to provide a customization module executable by the processing unit for customizing the categories created by the categorization module of the purchaser on signing in the purchaser online account.

Another object of the present invention is to provide a uniform module executable by the processing unit to uniform the categories received from the categorization module. Further, includes a direct module executable by the processing unit for receiving the items directly from the purchaser to add in the retrieval module.

Another object of the present invention is to provide a behavior module executable by the processing unit for creating a purchaser behavior profile based on at least one: purchases of the items; location of purchaser; and location of purchases. Further, the system includes an advertising module executable by the processing unit for advertising on the purchaser account based on the behavior module.

Another object of the present invention is to provide a monetary limit module executable by the processing unit allows the purchaser to set monetary limits per category created under category module. Further, system includes a notification module executable by the processing unit for sending notifications to the purchaser on reaching close to the set monetary limits per category set under the monetary limit module.

Another object of the present invention is to provide a family module executable by the processing unit for adding family members to the purchaser account created under the registration module.

These and other features and advantages will become apparent from the following detailed description of illustrative embodiments thereof, which is to be read in connection with the accompanying drawings.

### BRIEF DESCRIPTION OF DRAWINGS

FIG. 1 illustrates a block diagram of a system for itemizing the financial transactions of a purchaser in accordance with a preferred embodiment of the present invention;

FIG. 2 illustrates a schematic diagram of registration module in accordance with a preferred embodiment of the present invention;

FIG. 3 illustrates a block diagram of the retrieval module for retrieving the items and the money spend on each item from the electronic receipt information in accordance with a preferred embodiment of the present invention;

FIG. 4 illustrates a block diagram of the categorization module for categorizing the items and customization module for modifying existing categories in accordance with a preferred embodiment of the present invention;

FIG. 5 illustrates a pie chart of a graphical presentation created by the computing module in an exemplary embodiment of the present invention; and

FIG. 6 illustrates a block diagram of behavior module in accordance with another preferred embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF DRAWINGS

While this technology is illustrated and described in a preferred embodiment, itemizing the financial transactions of a purchaser, may be produced in various configurations and computer languages. This is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

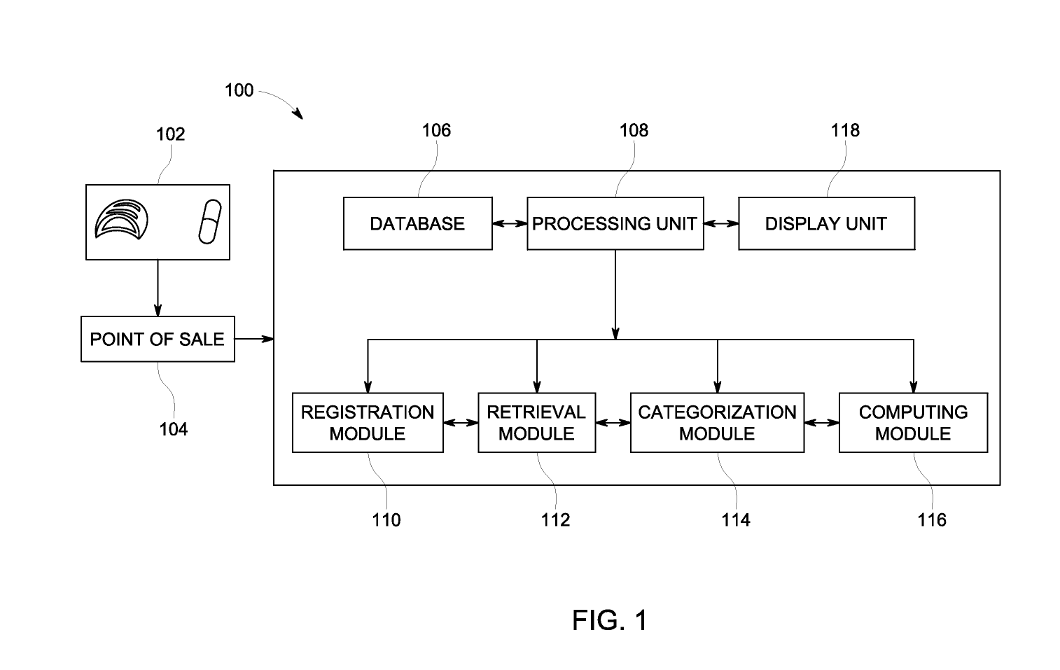

FIG. 1 illustrates a block diagram of a system 100 for itemizing the financial transactions of a purchaser based on electronic receipt information generated corresponding to sale of one or more items 102 at a point of sale 104 in a preferred embodiment of the present invention. The system 100 includes a database 106, a processing unit 108 coupled to the database 106, a registration module 110, a retrieval module 112, a categorization module 114, a computing module 116 and a display unit 118 for displaying the information executed by the processing unit 108.

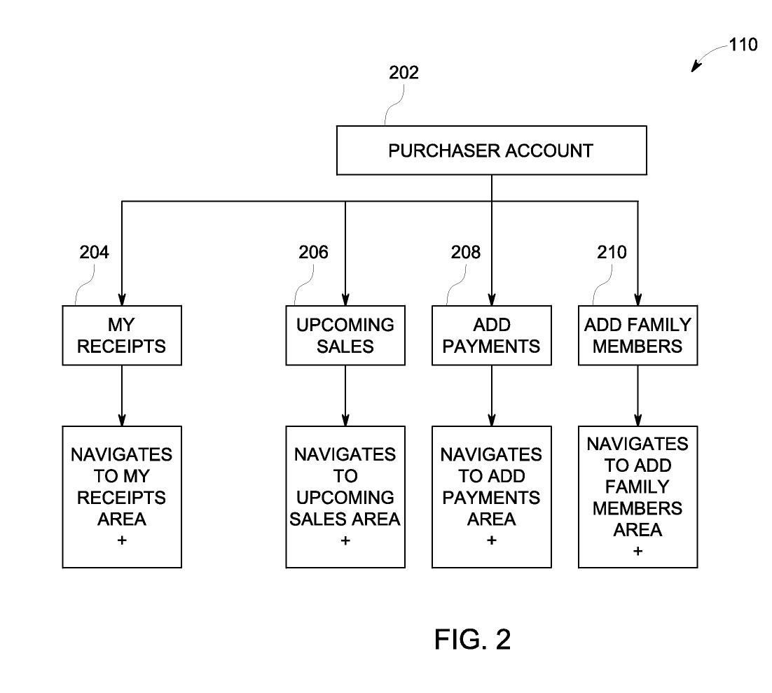

The registration module 110 is executable by the processing unit 108 for creating a purchaser account on receiving the information related to the purchaser. The purchaser account may be created on the registration module by entering information such as name, email ID, payment modes, address, and password. Further, the purchaser account stores the electronic receipt information related to the purchaser received from the point of sale 104. The registration module 110 is explained in detail in conjunction with FIG. 2 of the present invention.

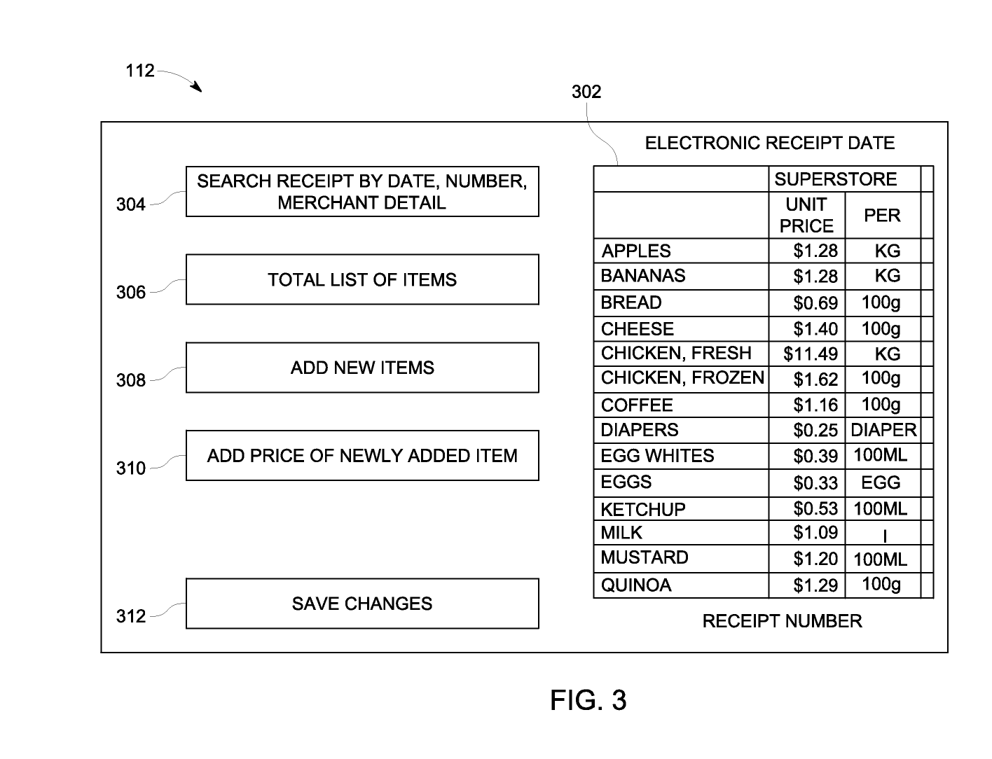

The retrieval module 112 is executable by the processing unit 108 for retrieving the items and the money spend on each item from the electronic receipt information to the purchases made by the purchaser at the point of sale 104. The retrieval module 112 is majorly a back-end process that receives the electronic receipt information only of the purchaser who has created the purchaser account in the registration module 110. The electronic receipt information is explained in detailed in conjunction with FIG. 3 of the present invention.

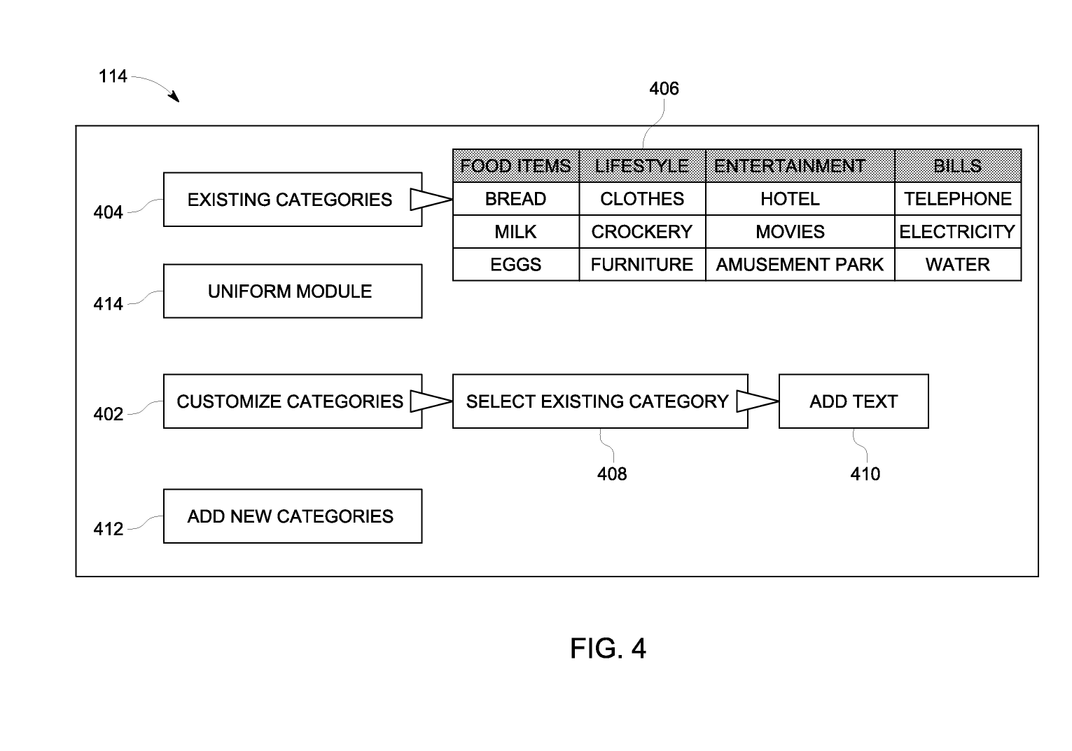

The categorization module 114 is executable by the processing unit 108 for creating and storing categories of the items retrieved by the retrieval module 112 from the electronic receipt information in the purchaser account. The categorization module 112 is explained in detail in conjunction with FIG. 4 of the present invention.

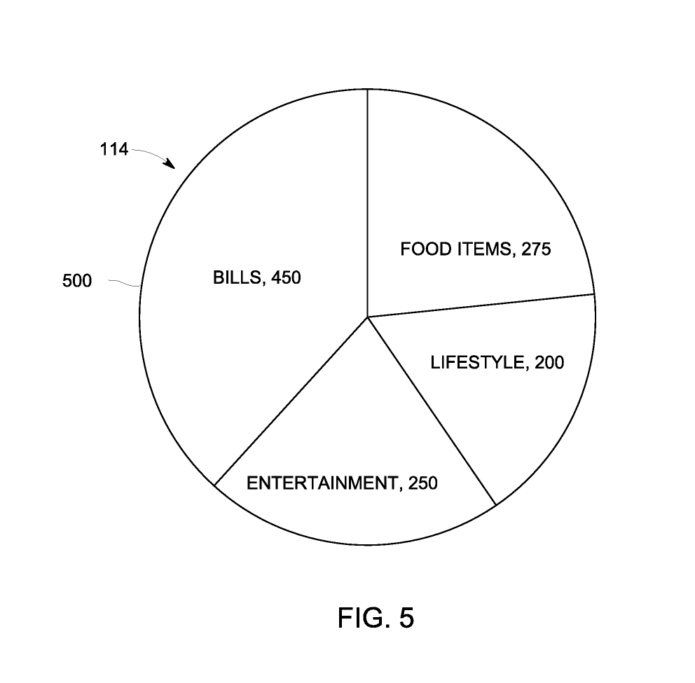

The computing module 116 is executable the processing unit 108 for the computing the information retrieved from the retrieval module 112 and the categorization module 114 for generating a graphical presentation of the money spend on each item purchased by the purchaser at the point-of-sale. The graphical presentation is shown and explained in detail in conjunction with FIG. 5 of the present invention.

In another preferred embodiment of the present invention, the system 100 further includes a customization module executable the processing unit 108 for customizing the categories created by the categorization module 114 of the purchaser on signing in the purchaser account.

The customization module allows the purchaser to modify existing categories stored in the database and is further allowed to add new categories to the existing list of categories. The customization module is further explained in detail in conjunction with FIG. 4 of the present invention.

In another preferred embodiment of the present invention, the system 100 further includes a uniform module executable by the processing unit to uniform the categories received from the categorization module 114. The uniform module is further explained in detail in conjunction with FIG. 4 of the present invention.

In another preferred embodiment of the present invention, the system 100 further includes a direct module executable by the processing unit 108 for receiving the items directly from the purchaser to add in the retrieval module. The direct module is further explained in detail in conjunction with FIG. 3 of the present invention.

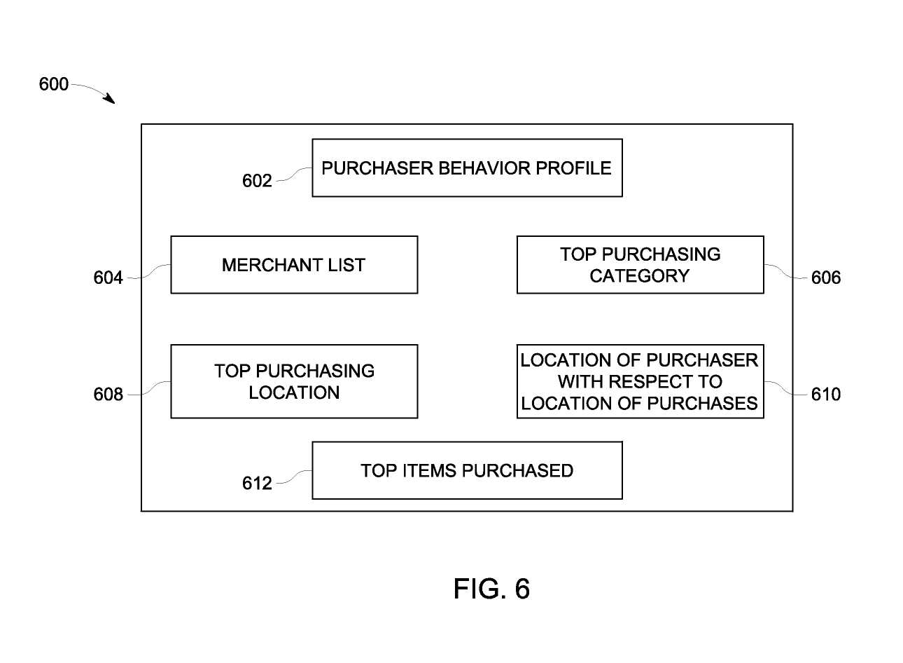

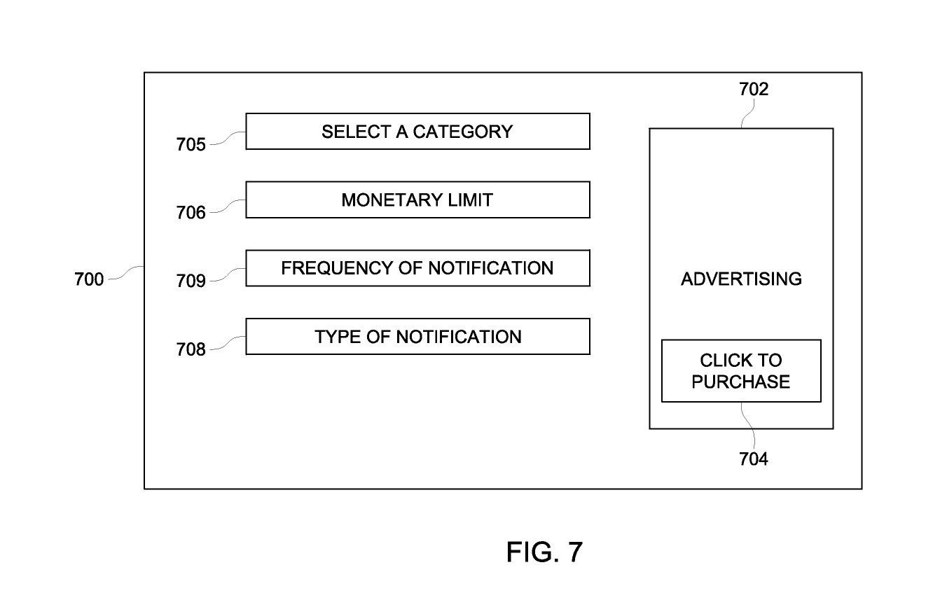

In another preferred embodiment of the present invention, the system 100 further includes a behavior module for executable by the processing unit 108 for creating a purchaser behavior profile based on at least one of: purchases of the items; location of purchaser; and location of purchases. The behavior module is explained in detail in conjunction with FIG. 6 of the present invention.

In another preferred embodiment of the present invention, the system 100 further includes an advertising module executable by the processing unit 108 for advertising on the purchaser account based on the purchaser behavior profile. The advertising module is explained in detail in conjunction with FIG. 7 of the present invention.

In another preferred embodiment of the present invention, the system 100 further includes a monetary limit module by the processing unit 108 allows the purchaser to set monetary limits per category created under category module. The monetary limit module is explained in detail in conjunction with FIG. 7 of the present invention.

In another preferred embodiment of the present invention, the system 100 further includes a notification module executable by the processing unit 108 for sending notifications to the purchaser on reaching close to the set monetary limits per category set under the monetary limit module. The notification module is explained in detail in conjunction with FIG. 7 of the present invention.

In another preferred embodiment of the present invention, the system 100 further includes a family module executable by the processing unit 108 for adding family members to the purchaser account created under the registration module. The family module is explained in detail in conjunction with FIG. 2 of the present invention.

In another preferred embodiment of the present invention, the system 100 further includes a purchasing module to connect to a third party for purchasing of items through the advertising module. The purchasing module is explained in detail in conjunction with FIG. 7 of the present invention.

FIG. 2 illustrates a schematic diagram of the registration module 110 in accordance with a preferred embodiment of the present invention. The registration module 110 opens a purchaser account 202 in the database for the purchaser. The purchaser account 202 provides access to the purchaser to view my receipts 204 for viewing stored electronic receipt information.

Further, the purchaser account 202 further allows the purchaser to view upcoming sales 206 for providing advertising of future sales from the advertisement module, add payments 208 for allowing the purchaser to add payment methods for purchasing items through the purchasing module, and a family module 210 for adding family members to the existing purchaser account. The purchasing module is explained in detail in conjunction with FIG. 7 of the present invention.

FIG. 3 illustrates a block diagram of the retrieval module 112 for retrieving the items and the money spend on each item from the electronic receipt information 302. The retrieval module 112 further includes a receipt search module 304, items module 306, add new item module 308, and add price of newly added item module 310.

The electronic receipt information 302 displays the list of purchased items along with the receipt number and the receipt date. The receipt search module 304 allows the purchaser to search stored receipts either by entering the date of purchasing, receipt number or merchant name. The items module 306 displays the list of each item retrieved from the electronic receipt information.

The add new item module 308 allows the purchaser to add any of the item directly into the database and the add price of newly added item module 310 allows the purchaser to add the price of newly added item. This allows the purchaser to keep track of those items which are generated through the point of sale. The retrieval module further allows the purchaser to save the changes to update the database through the save changes module 312.

FIG. 4 illustrates a block diagram of the categorization module 114 for categorizing the items and customization module 402 for modifying existing categories in accordance with a preferred embodiment of the present invention. The categorization module 114 allows viewing of each categorizes and items associated under existing categories module 404.

Further, the categorization module 114 categorizes each item into categories as shown in table 406. The table 406 shows items like bread, milk and eggs are categorized under category ‘food items’. Further, items like clothes, crockery and furniture are categorized under category ‘lifestyle’. It would be readily apparent to those skilled in the art that various items and categorizes may be envisioned without deviating from the scope of the present invention.

The customization module 402 allows the customization of existing categories stored in the database. The purchaser selects a category under a select existing category module 408 and then adds text under add text module 410 for customizing the existing category. The customization module 402 further allows adding of new categories through add new categories module 412 to the existing categories module 404.

With reference from FIG. 1, the uniform module 414 uniforms each category received from the categorization module 114. For exemplary purpose, the uniform module 414 uniforms categories such as food item, foods, food items to one category as food items. The category with largest items prevails in the database.

FIG. 5 illustrates a pie chart of a graphical presentation 500 created by the computing module 116 in an exemplary embodiment of the present invention. With reference to the list of categories displayed in the table 406 in FIG. 4, the computing module 116 displays the graphical presentation 500 to show money spend on each categories in a pre-defined time period. For example, the purchaser spends $450 on bills, $275 on food items, $250 on entertainment and $200 on lifestyle.

FIG. 6 illustrates a block diagram of behavior module 600 in accordance with another preferred embodiment of the present invention. The behavior module 600 creates a purchaser behavior profile 602 based on at least one of the:

Merchant List 604—provides the list of all merchants from where the items were bought. The merchant list 604 may either be arranged in ascending or descending order based on spending money on items at each merchant. This helps in setting advertising on the purchaser profile through the advertisement module in relation with offers available at the top merchants under Merchant list 604.

Top Purchasing Category 606—provides the list of purchases made in top categories by the purchaser. This helps in setting advertisement on interested categories on the purchaser profile through the advertisement module.

Top Purchasing Location 608—provides the list of purchases made in top location by the purchaser. Herein, the location refers to city, state and country. This helps in setting advertisement related to offers available at top location through the advertisement module.

Location of Purchaser with respect to Location of Purchases—provides list of location of purchaser with respect to the purchases. This is to understand the behavior of purchaser in purchasing items from various locations. This helps in setting advertising through the advertisement module on the basis of purchases of items made at various location of the purchaser.

Top Items Purchased 612—provides list of top items purchased by the user. This helps in setting advertisement on interested items on the purchaser profile through the advertisement module. The advertisement module is explained in detail in conjunction with FIG. 7 of the present invention.

FIG. 7 illustrates a block diagram 700 of advertising module 702, purchasing module 704, monetary limit module 706 and notification module 708 in accordance with another preferred embodiment of the present invention. The advertising module 702 displays advertisement of items with respect to the purchaser behavior profile.

The purchasing module 704 allows the purchaser to purchase the items displayed by the advertisement module 702. The purchasing module 704 may further take the purchaser to a third party website for purchasing of the items in another preferred embodiment of the present invention.

The monetary limit module 706 allows the purchaser to set a monetary limit for sending notifications through the notification module 708 on exceeding the limit. The purchaser first select the category under select a select a category module 705 and then enters the $ amount in the monetary limit module 706. The notification module 708 sends the notification either by message, voice call, text, email, or in combination etc.

A frequency of notification module 709 allows the purchaser to set frequency of the notification to be send through the notification module 708. For example, for a category as lifestyle, monetary limit set as $150, frequency of notification as 4, type of notification as email is set by the purchaser. Then, the processor sends email to the purchaser 4 times when the purchaser is about to spend $150 on food.

The present invention offer various advantages not limited to one store (chain) or loyalty program. Further, the system targets each purchaser separately based on the purchases even on group budget. The present invention further allows the purchaser to create budget on each category and thus saves their money in controlling purchases on non-required items. Further, provides stats on a variety of products or metrics by region, time or demographics.

There has thus been shown and described a system for itemizing the financial transactions of a purchaser. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A system for itemizing the financial transactions of a purchaser based on electronic receipt information generated corresponding to purchases of one or more items at a point-of-sale, the system comprising:
a database;
a processing unit coupled to the database;
a registration module executable by the processing unit for creating a purchaser account on receiving the information related to the purchaser, further the purchaser account stores the electronic receipt information related to the purchaser received from the point of sale;
a retrieval module executable by the processing unit for retrieving the items and the money spend on each item from the electronic receipt information related to purchases made by the purchaser at the point of sale;
a categorization module executable by the processing unit for creating and storing categories of the items retrieved by the retrieval module in the purchaser account;
a computing module executable by the processing unit for computing the information retrieved from the retrieval module and the categorization module for generating a graphical presentation of the money spend on each item purchased by the purchaser at the point of sale; and
a display unit for displaying the data executed by the processing unit.

2. The system according to claim 1 further comprising a customization module executable by the processing unit for customizing the categories created by the categorization module of the purchaser on signing in the purchaser account.

3. The system according to claim 1 further comprising a uniform module executable by the processing unit to uniform the categories received from the categorization module.

4. The system according to claim 1 further comprising a direct module executable by the processing unit for receiving the items directly from the purchaser to add in the retrieval module.

5. The system according to claim 1 further comprising a behavior module executable by the processing unit for creating a purchaser behavior profile based on at least one of: purchases of the items; location of purchaser; and location of purchases.

6. The system according to claim 5 further comprising an advertising module executable by the processing unit for advertising on the purchaser account based on the purchaser behavior profile.

7. The system according to claim 1 further comprising a monetary limit module executable by the processing unit allows the purchaser to set monetary limits per category created under category module.

8. The system according to claim 7 further comprising a notification module executable by the processing unit for sending notifications to the purchaser on reaching close to the set monetary limits per category set under the monetary limit module.

9. The system according to claim 1 further comprising a family module executable by the processing unit for adding family members to the purchaser account created under the registration module.

10. The system according to claim 6 further comprising a purchasing module to connect to a third party for purchasing of items through the advertising module.

11. A method for itemizing the financial transactions of a purchaser based on electronic receipt information generated corresponding to sale of one or more items at a point-of-sale, the method comprising the steps of:
creating a purchaser account on receiving the information related to the purchaser through a registration module;
storing the electronic receipt information related to the purchaser received from the point of sale through the registration module;
retrieving the items and the money spend on each item from the electronic receipt information related to purchases made by the purchaser at the point of sale through a retrieval module;
creating and storing categories of the items retrieved by the retrieval module in the purchaser account through a categorization module; and
computing the information retrieved from the retrieval module and the categorization module for generating a graphical presentation of the money spend on each item purchased by the purchaser at the point of sale through a computing module.

12. The method according to claim 11 further comprising the step of customizing the categories created by the categorization module of the purchaser on signing in the purchaser account through a customization module.

13. The method according to claim 11 further comprising the step of uniforming the categories received from the categorization module through a uniform module.

14. The method according to claim 11 further comprising the step of receiving the items directly from the purchaser to add in the retrieval module through a direct module.

15. The method according to claim 11 further comprising the step of creating a purchaser behavior profile based on at least one of: purchases of the items; location of purchaser; and location of purchases through a behavior module.

16. The method according to claim 15 further comprising the step of advertising on the purchaser account based on the purchaser behavior profile through an advertisement module.

17. The method according to claim 11 further comprising the step of setting monetary limits per category created under category module through a monetary limit module.

18. The method according to claim 17 further comprising the step of sending notifications to the purchaser on reaching close to the set monetary limits per category set under the monetary limit module through a monetary limit module.

19. The method according to claim 11 further comprising the step of adding family members to the purchaser account created under the registration module through a family module.

20. The method according to claim 16 further comprising the step of connecting to a third party for purchasing of items via the advertising module through a purchasing module.
